(19) United States
(12) Patent Application Publication
(10) Pub. No.: US 2009/0161109 A1
(43) Pub. Date: Jun. 25, 2009

(54) OPTICAL SENSOR FOR DETECTING MOISTURE ON A WINDOW OF A MOTOR VEHICLE

(76) Inventors: Frank Wolf, Buehl (DE); Vladislav Matusevich, Jena (DE); Manfred Tettweiler, Wilhelmshaven (DE); Richard Kowarschik, Schleiz (DE); Andrew Matusevich, Jena (DE)

Correspondence Address: KENYON & KENYON LLP, ONE BROADWAY, NEW YORK, NY, 10004, US

(21) Appl. No.: 11/665,165

(22) PCT Filed: Sep. 20, 2005
(86) PCT No.: PCT/EP05/54671

§ 371 Date: Jan. 16, 2009

(30) Foreign Application Priority Data
Oct. 16, 2004 (DE) 10 2004 050765.1

(51) Int. Cl. G01N 21/55

(52) U.S. Cl. 356/445

(57) ABSTRACT

In order also to allow the detection, for example, of condensation of the inner side of an interface (window) using motor-vehicle rain sensors that exploit the interference, at a window wetted with moisture, with total reflection of light irradiated by a transmitter, several sensors are proposed that are sufficiently variable in terms of configuration and function that they contain, without complex adaptation actions, an implementable possibility for selectable inside/outside detection simultaneously with good discrimination between outside and inside wetting.

### FIELD OF THE INVENTION

The present invention relates to an optical sensor for detecting moisture on a window of a motor vehicle, in which sensor an attenuation of a light emitted from a transmitter upon reflection at an interface of the window by moisture is sensed with the aid of a receiver.

### BACKGROUND OF THE INVENTION

An optical sensor of this kind operating according to the total reflection principle is known, for example, from German Patent Publication No. DE 42 09 680. Optical sensors of this kind are known in many variations, and are used at present in motor vehicles as so-called rain sensors, which can serve in particular to (automatically) control windshield wiper systems. These sensors typically, but not universally, use at least a portion of the (front) window as an optical waveguide.

The optical detection method predominantly used in present-day rain sensors is based firstly on the fact that as is known, light can propagate in a waveguide by total reflection because the reflection medium, i.e. the jacket or environment of the waveguide, has a lower refractive index than the waveguide core. The light introduced into the waveguide at a sufficiently large angle (>42°) with the aid of a coupling means (e.g. a prism) is at first totally reflected by the boundary surfaces of the window, since when the interface is dry, the light beam angle is large enough to prevent splitting into a reflected and a transmitted light bundle. If a raindrop then wets the light channel, the critical angle applicable to the media transition that is thereby modified (from glass/air to glass/water) is increased from 42° to 60°, so that a larger portion of the light—coupled in at an angle between 42° and 60° in terms of functionality as a rain sensor—now emerges through that droplet. The weakening light transmission capability of the channel as a function of moisture is measured at the outcoupling point (once again a prism or the like) with the aid of photodiodes or phototransistors.

### SUMMARY OF THE INVENTION

Rain sensors usually use the vehicle's front window or windshield, or a region of the windshield which often extends over only a few centimeters and the wetting of which with raindrops or other moisture droplets is to be detected, as a waveguide into which light is coupled in from the inner side of the windshield by means of suitable coupling means, for example prisms or holographic coupling films, and coupled back out again. Because on the one hand the non-transparent parts of the rain sensor (transmitter/receiver, housing, evaluation electronics) must not interfere with the driver's field of view, and on the other hand the detection region of the sensor must be mounted in a region of the windshield that is cleaned by the windshield wiper system, sensor versions have now also been developed in which an additional waveguide, not constituted by the window itself, serves to span the distance between the detection region and the other parts of the rain sensor, i.e. to span those regions of the windshield not cleaned by the wipers.

For example, a rain sensor is known from German Patent Publication No. DE 199 43 887 A1 in which light is guided, in a flat waveguide disposed on the inner side of the windshield, bidirectionally between a peripherally disposed transmitter/receiver and a relatively central region of the window. At the desired region of the window, light is coupled out from the waveguide in such a way that it passes through the window to its outer side in the desired rain detection region, is totally reflected, and is then reflected back into the waveguide by a retroreflector disposed on the inner side of the window, once again with total reflection at the detection region. Also known, from German Patent Publication No. DE 102 29 239, is a rain sensor in which the additional waveguide is constituted in an intermediate layer of a laminated glass window. Here as well, light is coupled out at a suitable point only to the outer side of the window, totally reflected there, and coupled back into the internally located waveguide, so that moisture present in the detection region on the outer side of the window results, in desirable fashion, in attenuation of the light beam by partial outcoupling, which can then be evaluated in known fashion.

A problem that is known from the aforementioned German Patent Publication No. DE 42 09 680 of the species, in connection with the standard rain sensor type therein in which the light is totally reflected several times at the outer and the inner side of the vehicle window, is that any wetting of the inner side of the window, for example by condensation, also results in a partial outcoupling of the radiation, and thus in a beam attenuation that cannot be distinguished from the influence of the wetting (on the outer side of the window) that is actually to be detected. In order to exclude this influence that is considered undesirable, it is proposed in the context of the known rain sensor to dispose a reflective film on the inner side of the window so that even in the event of wetting thereon, moisture-dependent attenuation of the light beam thus no longer occurs.

On the other hand, however, the known rain-only sensor obviously cannot simply be implemented as a condensation-only sensor by way of a reflective film disposed on the outer side rather than the inner side of the window, since transparency from inside to outside then could not readily be ensured, or other problems might occur, for example in terms of the durability of the film that is then externally located.

Because there is also, independently, increasing interest in the detection of moisture on the inner side of the windows of a motor vehicle as well, e.g. for automatic activation of the fan present in the motor vehicle, it is the object of the invention to create moisture sensors of the kind described above, i.e. in the context of the technologies utilized for external detection, that are sufficiently variable in terms of configuration and function that they encompass a capability, implementable without complex adaptation actions, for selectable interior/exterior detection simultaneously, with good discrimination between exterior and interior wetting.

In the case of the alternative manner of achieving the object according to Claim 1, the light is guided bidirectionally between the at least one transmitter and at least one receiver, in the window or in a light-guiding element, to a retroreflector disposed on the inner side of the window, the light being totally reflected several times at the outer side of the window. The retroreflector is furthermore embodied as a photorefractive phase-conjugated mirror (PCM) whose geometry is selected so that its reflectivity substantially disappears upon wetting of its surface with moisture. This configuration is usable both in a sensor in which the window itself serves as a optical waveguide and in a sensor type such as the one known from German Patent Publication No. DE 199 43 887 A1 described above. When a light beam is coupled in at an angle of between 42° to 60°, the sensor then functions (when the inner side of the window is dry) as a rain sensor; whereas when the inner side of the window is wet, the sensor indicates the presence of condensation because of the disappearance of the light beam and of the signal to evaluated, regardless of whether the outer side of the window is then dry or wet. In addition to this situation-dependent “self-switching” of the detection mode, the light beam can also be coupled in (with an otherwise identical configuration) at an angle of more than 60°, so that the sensor functions as a condensation-only sensor having two indicating states: signal unattenuated and signal disappeared. If applicable, it is also possible to provide, for selectable incoupling, a first transmitter with which a light beam is coupled in at an angle of more than 60°, and a second transmitter with which the light beam is coupled in at an angle of less than 60°.

In an alternative proposed manner of achieving the object according to the present invention, the light propagates in the window from the transmitter to the receiver, the light being totally reflected several times at the outer and the inner side of the window; and two holographically embodied grating structures, having different diffractive effects, are incorporated into an intermediate layer of the window, which structures diffract the light in such a way that it is totally reflected at the one side of the window at an angle of more than 60°, and at the opposite side of the window at an angle of between 42° and 60°. The result of this feature is that total reflection is disrupted only on one side of the optically guiding window by any moisture droplets that may possibly be present thereon, that side being selectable beforehand upon manufacture of the window or of the sensor. The system can thus be selectively adjusted, exclusively by holographic means, to detect as a rain sensor or a condensation sensor.

An advantageous variation of this alternative manner of achieving the object consists in the fact that the window is embodied as a laminated glass window; and that the holographic grating structures are incorporated into a photosensitively doped adhesive intermediate layer, or into a photosensitive polymer layer integrated into the laminated glass window.

In the case of the further alternative proposed manner of achieving the object according to the present invention, there is disposed on the inner or the outer side of the window a multimode foil- or film-like optical waveguide in which the light is coupled in from the transmitter and coupled out to a receiver in such a way that in the absence of any wetting with moisture on the exposed outer side of the optical waveguide, the light propagates in unattenuated fashion with total reflection. It is thus possible to produce a rain-only sensor when the thin waveguide is disposed externally on the window, and a condensation-only sensor when it is disposed internally.

In the case of the further alternative proposed manner of achieving the object according to the present invention, the light is guided between the transmitter and a receiver in a laminar waveguide that is disposed on the adhesive intermediate layer of a laminated glass window; and at least one coupling element is provided in order to couple the light out of the waveguide to the inner or the outer side of the window, and couple back into the waveguide the light that is totally reflected at least once at the respective side of the window. The placement between the adhesive intermediate layer and a glass layer yields a particularly large number of degrees of freedom for coupling the light beam out to the desired side of the window and thereby implementing a rain-only sensor or a condensation-only sensor. In addition, it is readily possible to dispose two laminar waveguides one above another or on different sides of the intermediate layer, thus resulting in a double sensor that can function simultaneously as a discriminating rain-only sensor and as a condensation-only sensor that is uninfluenced by external moisture.

This alternative manner of achieving the object is particularly advantageous in combination with a variant in which the waveguide is constituted by an infrared-reflecting polymer film integrated into the laminated glass for heat rejection, since considerable advantages in terms of manufacturing engineering result from utilization of the existing layer as a waveguide.

### BRIEF DESCRIPTION OF THE DRAWINGS

Exemplifying embodiments of the invention are explained below with reference to the drawings, in which, in each case schematically and in cross section:

FIG. 1 shows a moisture sensor according to the present invention in a first embodiment, with a PCM retroreflector.

FIG. 2 shows the operating principle of the PCM retroreflector according to FIG. 1.

FIGS. 3a and b show two different moisture-dependent operating modes of the sensor according to FIGS. 1 and 2.

FIG. 4 shows an alternative embodiment of the sensor according to the present invention.

FIG. 5 shows a further alternative embodiment of the moisture sensor according to the present invention.

FIG. 6 shows a further alternative embodiment of the sensor according to the present invention.

FIG. 7 shows a variant of the sensor depicted in FIG. 6.

### DETAILED DESCRIPTION

The exemplifying embodiments according to each of FIGS. 1 to 3 are based on a glass window 5 as a waveguide, in which light beam 1, 4 is guided bidirectionally with multiple reflection to both outer side 6 and inner side 7 of window 5, light beam 1 being reflected back at a mirror 8 (phase-conjugated mirror, PCM) disposed on inner side 7 of window 5. Also possible, however, is a variant (not depicted here) of this embodiment of the sensor according to the present invention having a PCM, in which a configuration is implemented having an additional waveguide disposed on the inner side of window 5, approximately in the fashion that exists in the context of the existing art, mentioned and described above, according to German Patent Publication No. DE 199 43 887.

FIG. 1 depicts a light beam 1 that is coupled into window 5, propagates by total reflection to phase-conjugated mirror 8, is reflected there and guided back as phase-conjugated light beam 4 again by total reflection, then finally coupled back out of window 5 and conveyed via a beam splitter 9 to a receiver that, like the transmitter, is not depicted here or in any of the following Figures. Beam splitter 9 serves, in a manner known per se, for optical separation of the output from the input signal. PCM 8 is moreover approximately transparent. The phase-conjugated mirror 8 that is used has, firstly, the advantage of ensuring accurate reflection for bidirectional light wave guidance without requiring complex alignment actions as in the case of other retroreflectors used in moisture sensors. As usual, a water droplet 10—located, for example as depicted in FIG. 1, on outer side 6 of window 5—results in known fashion, in accordance with the detection principle based on interference with total reflection (in this case at the interface between window exterior and water), in a detectable attenuation of light beam 1 or 4.

Nonlinear photorefractive materials, for example photorefractive crystals, liquid crystals, or polymers, can advantageously be used for phase-conjugated mirror 8, which is known per se.

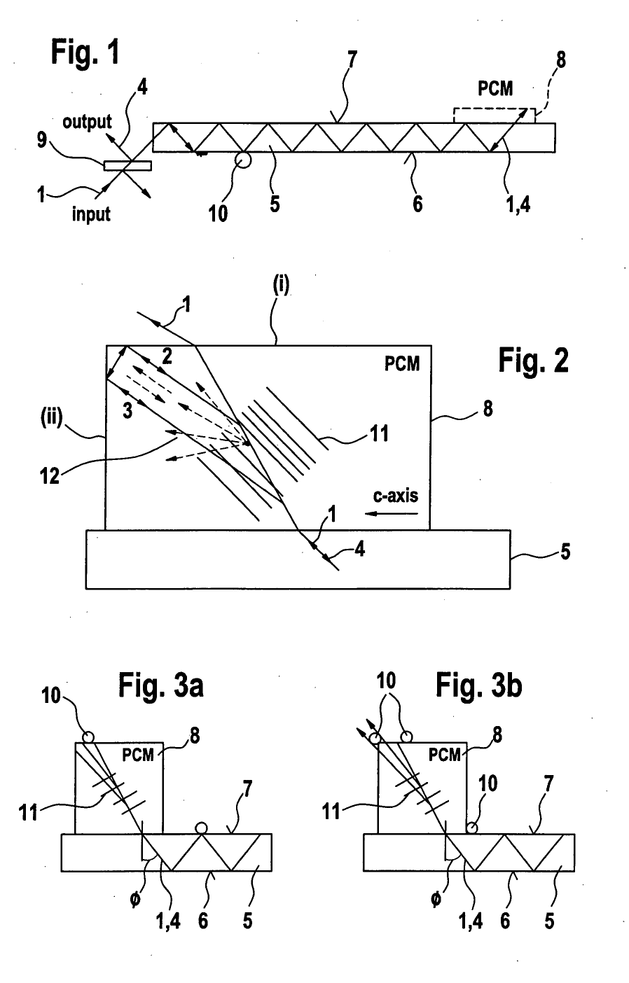

FIG. 2 shows the implementation and function of a PCM by way of phase gratings (refractive-index gratings) 11 generated in photorefractive materials, using the example of a parallelepipedal photorefractive crystal 8. So-called holographic or light-induced scattering is usually understood as the following nonlinear process: An incident light wave interacts with coherent scattered waves that are produced as a result of inhomogeneities in the interior or on the surface of a material. The resulting light patterns generate, in a photorefractive crystal, various refractive-index gratings at which the primary wave is in turn diffracted. Specifically, in accordance with the exemplifying embodiment depicted in FIG. 2, beam 1 penetrates from the window/crystal interface into crystal 8 and experiences directional self-scattering 12 along the optical c axis of crystal 8 indicated in FIG. 2. The unscattered portion of beam 1 passes through crystal 8, while the scattered light, distributed in a specific region (beam 2), is totally reflected, as depicted, at interfaces (i) and (ii) and forms beam 3. Beam 3 is refracted at phase grating 11 generated by beams 1 and 2, and forms beam 4 that is phase-conjugated with beam 1.

FIG. 3 shows the manner in which PCM 8 also, according to the present invention, performs a further moisture-dependent function in addition to its reflective function. If light 1, 4 is coupled into window 5 at, for example, an angle φ of more than 60°, i.e. at a critical angle that is too large for partial outcoupling at an interface produced by any wetting of window 5, no light intensity losses during bidirectional wave guidance in window 5 then occur even in the case of moisture 10, e.g. condensation, on one or both sides 6 and 7 of window 5. If, according to the present invention, the geometrical parameters of phase-conjugated mirror 8 are at the same time selected so that no beam outcoupling from PCM 8 itself occurs provided dry conditions exist on its surface, i.e. on window inner side 7 (cf. FIG. 3a), the sensor then functions here as a condensation-only sensor. The sensor accordingly reacts only to droplets 10 that are present on window inner side 7 and therefore also on the surface of the photorefractive material of PCM 8. The reaction (cf. FIG. 3b) consists in a disappearance, associated with the moisture-related beam outcoupling, of the detector signal, thereby unequivocally indicating the presence of condensation.

As already mentioned above, other modes of operation can also be selected. For φ between 42° and 60°, the sensor (when inner side 7 is dry) functions as a rain sensor that, even when inner side 7 is wet, does not simply lose its discriminating property by permitting the inner-side wetting to have an unnoticed influence on the detected signal. Instead, in this case, in the presence of condensation the signal disappears entirely because of the moisture-sensitive reflection capability of PCM 8, allowing an unequivocal evaluation as condensation; that evaluation then itself, in turn, remains uninfluenced by the presence or absence of moisture 10 on window outer side 6. The rain-sensor functionality remains disabled as long as condensation is present.

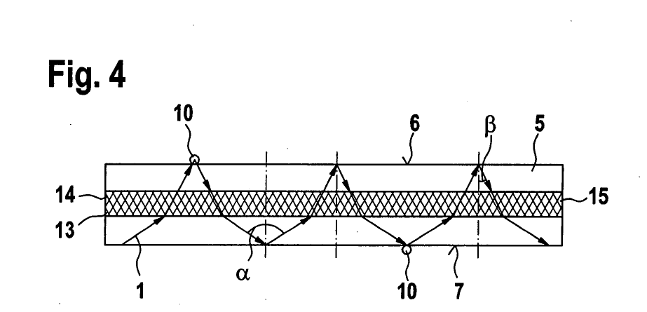

FIG. 4 shows an exemplifying embodiment that refers to an alternative embodiment of the moisture sensor according to the present invention. It shows a wave-guiding laminated glass window 5 in which incoupled light 1 propagates from the transmitter to the receiver, light 1 being totally reflected several times at outer side 6 and inner side 7 of window 5. Two holographically embodied grating structures 13, 14, having different diffractive effects, are incorporated into an intermediate layer 15 of window 5. They diffract the light so that, in the exemplifying embodiment depicted, it is totally reflected at inner side 7 of window 5 at an angle α of more than 60°, and at the oppositely located outer side 6 of window 5 at an angle β of between 42° and 60°. This makes possible, without external optical or mechanical actions or means, a complete discrimination between external and internal wetting. In the example shown (a rain sensor), only water droplets 10 on outer side 6 influence the propagation of beam 1 and thus the detected signal. The separation of rain influences and condensation influences can, however, also be implemented, with the aid of reversed multiplex grating structures 13 and 14 and incoupling angles α and β, so that the sensor reacts only to moisture on inner side 7 of window 5.

It is advantageous in terms of manufacturing engineering if the holographic grating structures 13 and 14 are incorporated into a photosensitively doped, adhesive intermediate layer 15, or into a photosensitive polymer layer integrated into the laminated glass window.

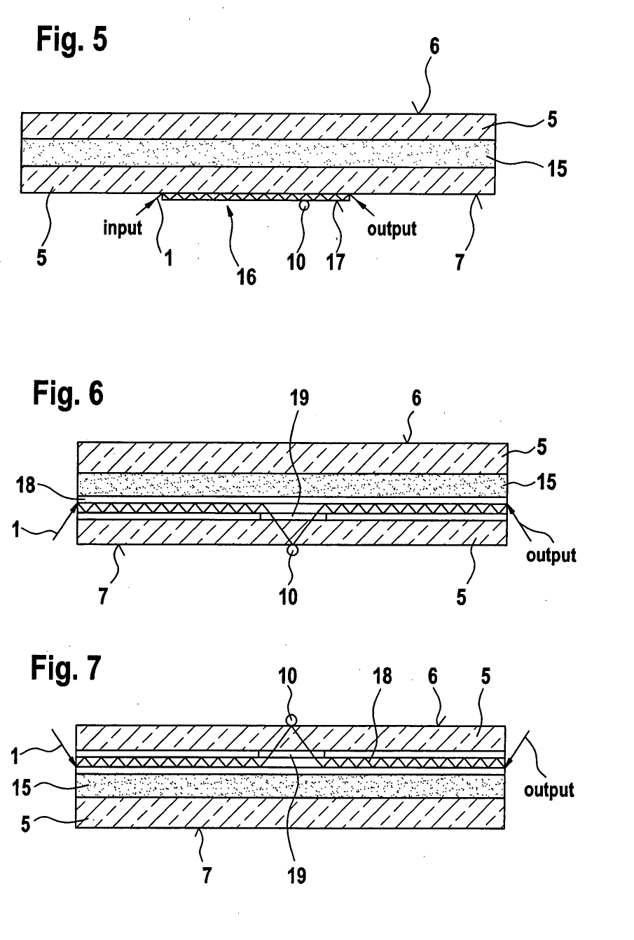

FIG. 5 shows an exemplifying embodiment according to a further alternative manner of achieving the moisture sensor according to the present invention. In this example, there is disposed on inner side 7 of window 5 a multimode foil- or film-like optical waveguide 16 in which light 1 is coupled in from the transmitter at an angle of between 42° and 60°, and coupled out to a receiver, in such a way that in the absence of any wetting with moisture 10 on the exposed outer side 17 of optical waveguide 16, light 1 propagates in unattenuated fashion by total reflection. The result is a condensation-only or rain-only sensor, depending on whether the thin waveguide 16 is mounted, for example by adhesive bonding, on inner side 7 or outer side 6 of window 5. The condensation sensor shown in FIG. 5 can, advantageously, additionally be used as a conventional rain sensor.

A further alternative embodiment is shown in FIGS. 6 and 7. Light 1 is guided between the transmitter and a receiver in a laminar waveguide 18 that is disposed on the adhesive intermediate layer 15 of a laminated glass window 5. At least one coupling element 19 is also provided in order to couple light 1 out of waveguide 18 to inner side 7 or to outer side 6 of window 5, and in order to couple light 1, totally reflected at least once at the respective window side 6 or 7, back into waveguide 18. Light 1 can optionally also be coupled out with the aid of multiple coupling elements 19 successively, for example to two or three detection points on the respective window side, and coupled between them back into waveguide 18 for propagation to the next coupling element 19. The embodiment according to FIG. 6 scans only one outcoupling point on inner side 7 of window 5, i.e. is a condensation-only sensor, whereas the sensor according to the exemplifying embodiment depicted in FIG. 7 scans only outer side 6 and a detection point located thereon, i.e. functions as a rain-only sensor. It is, also possible in principle for two laminar waveguides 18, having opposite detection sides, to be integrated above or next to one another in window 5.

Advantageously, an infrared-reflecting polymer film already present in the laminated glass for heat rejection can be used as waveguide 18. In general, a polymer or a glass layer approximately 200 μm thick is suitable as waveguide 18.

On the other hand, the embodiment of the invention depicted in FIGS. 6 and 7 is also particularly suitable for vehicle windows in which the glass layers as a whole exhibit light-absorbing properties for heat rejection, so that because of absorption or other effects, the light could not propagate in unattenuated fashion in the waveguide constituted by window 5 itself. The light source of the transmitter usually operates in the infrared range so as not to disturb the driver. The intensity loss would also be associated with a diminution of detection accuracy. According to the present invention, with the present embodiment the light needs to propagate only through the thickness of the glass layer of laminated glass window 5 that remains to be penetrated in order to reach the respective outcoupling side, and that only a few times at most, so that any absorption effects can have almost no undesirable consequences.

1-6. (canceled)

7. An optical sensor for detecting moisture on a window of a motor vehicle, comprising:
a transmitter for emitting light;
a receiver by which an attenuation of the light emitted from the transmitter upon reflection at an interface of the window by moisture is sensed;
a retroreflector disposed on an inner side of the window; and
an arrangement for guiding the light bidirectionally between the transmitter and the receiver, with multiple reflection at an outer side of the window, to the retroreflector, wherein:
the retroreflector includes a photorefractive phase-conjugated mirror (PCM), and
a geometry of the phase-conjugated mirror is selected so that its reflectivity substantially disappears upon wetting of its surface with moisture.

8. An optical sensor for detecting moisture on a window of a motor vehicle, comprising:
a transmitter for emitting a light beam;
a receiver by which an attenuation of the light beam emitted from the transmitter upon reflection at an interface of the window by moisture is sensed, the light beam propagating in the window from the transmitter to the receiver, and the light beam being reflected several times at an outer and an inner side of the window; and
two holographically embodied grating structures having different diffractive effects and being incorporated into an intermediate layer of the window, the grating structures diffracting the light beam so that it is reflected at one side of the window at an angle of more than 60°, and at an opposite side of the window at an angle of between 42° and 60°.

9. The optical sensor as recited in claim 8, wherein the window is embodied as a laminated glass window; and the holographic grating structures are incorporated into a photosensitively doped adhesive intermediate layer or into a photosensitive polymer layer integrated into the laminated glass window.

10. An optical sensor for detecting moisture on a window of a motor vehicle, comprising:
a transmitter for emitting a light beam;
a receiver by which an attenuation of the light beam emitted from the transmitter upon reflection at an interface of the window by moisture is sensed; and
a multimode foil- or film-like optical waveguide disposed on the inner or the outer side of the window, in which the light beam is coupled in from the transmitter and coupled out to the receiver in such a way that in the absence of any wetting with moisture on the exposed outer side of the optical waveguide, the light beam propagates in unattenuated fashion.

11. An optical sensor for detecting moisture on a window of a motor vehicle corresponding to a laminated glass window, comprising:
a transmitter for emitting a light beam;
a receiver by which an attenuation of the light beam emitted from the transmitter upon reflection at an interface of the laminated glass window by moisture is sensed;
a laminar waveguide in which the light beam is guided from the transmitter to the receiver, the laminar waveguide disposed on an adhesive intermediate layer of the laminated glass window; and
at least one coupling element provided in order to couple the light beam out of the laminar waveguide to the inner or outer side of the laminated glass window, and to couple back into the laminar waveguide the light beam that is reflected at least once at the respective window side.

12. The optical sensor as recited in claim 11, wherein the laminar waveguide includes an infrared-reflecting polymer film integrated into the laminated glass window for heat rejection.
